(19) United States
(12) Patent Application Publication
(10) Pub. No.: US 2007/0192831 A1
(43) Pub. Date: Aug. 16, 2007

(54) Microcontroller, authentication method for microcontroller, and authentication program for microcontroller

(76) Inventor: Shuichi Hashidate, Tokyo (JP)

Correspondence Address: NIXON PEABODY, LLP, 401 9TH STREET, NW, SUITE 900, WASHINGTON, DC, 20004-2128, US

(21) Appl. No.: 11/654,691

(22) Filed: Jan. 18, 2007

(30) Foreign Application Priority Data
Jan. 19, 2006 (JP) 2006-010641

(51) Int. Cl. H04L 9/32

(52) U.S. Cl. 726/2

(57) ABSTRACT

In one step of a program, an arbitrary value is written to an authentication code generation module. In the subsequent step, an authentication code is read from the authentication code generation module and it is determined whether the authentication code matches the value written in the preceding step. Normal processing is performed if the program is executed by a regular microcontroller that has an authentication code generation module. If the program is executed by another microcontroller that does not have the authentication code generation module, the authentication code cannot be read and, therefore, continuation of the processing becomes impossible. Accordingly, illegal use of a copied program can be prevented.

### BACKGROUND OF THE INVENTION

1. Field of the Invention

The present invention generally relates to a technology for the prevention of improper use of a program developed for a microcontroller.

2. Description of the Related Art

FIGS. 2A and 2B of the accompanying drawings show a conventional microcontroller 100. FIG. 2A illustrates a hardware constitution and FIG. 2B illustrates a software operation flowchart.

As shown in FIG. 2A, the microcontroller 100 includes a central processing unit (‘CPU’ hereinbelow) 1 that performs processing and control in accordance with programs and a reading dedicated memory (called the ‘ROM’ hereinbelow) 2 for storing the programs. The CPU 1 is connected to the ROM 2 via a bus 3. An I/O module 4 that sends and receives data to and from an external memory 10, for example, and another functional module 5 are also connected to the bus 3.

As shown in FIG. 2B, the software that controls the operation of the microcontroller 100 includes a main program for controlling the overall processing in accordance with the functions of the microcontroller 100 and a plurality of lower-order programs such as a function program that is activated by the main program to perform particular processing. For the sake of simplicity, FIG. 2B shows only one of the lower-order programs.

The operation of the microcontroller 100 shown in FIG. 2A and FIG. 2B will be described below.

For example, in step S1 of the main program, the CPU 1 reads data from the external memory 10 via the I/O module 4. After that, the lower-order program is activated in step S2 and the data are handed over to the lower-order program from the main program.

As a result, the operation of the lower-order program is started. In step S11, the handover of the data (input data) thus read is performed, and in step S12, computation processing is performed on the input data. When the computation in step S12 is complete, data (output data) of the computation result are generated in step S13. Then, the processing returns to the main program.

In step S3 of the main program, the CPU 1 receives the output data that have been generated by the lower-order program and writes the data to the external memory 10 via the I/O module 4.

Japanese Patent Application Kokai (Laid Open) No. H11-345117 discloses a processor equipped with a program illegal execution prevention function. This processor accepts normal processing and control commands and also accepts an execution permission command. The processor performs an authentication operation on the basis of a processor ID that is unique to the processor and a software ID that is unique to the program to be executed. The processor executes the program when the authentication operation ends successfully.

Japanese Patent Application Kokai No. 2001-209584 discloses an information encryption device that is constituted such that, when data stored in an internal storage medium, such as a hard disk, of a personal computer are copied to an external storage medium such as a CD (Compact Disc), the data are encrypted and copied in accordance with unique information that is set for the personal computer. When the encrypted data is read from the external storage medium, the data should be decrypted using that unique information. As a result, reading of the copied data in the external storage medium by another personal computer can be prevented.

Japanese Patent Application Kokai No. 2003-150457 discloses a technology for preventing the illegal use of electronic data. This technology uses a data storage medium having a copyright protection function. This data storage medium includes a data region in which electronic data such as software are stored and a protected region where a discriminatory ID is stored. The discriminatory ID is rewritable. The electronic data usage device described in Japanese Patent Application Kokai No. 2003-150457 reads the discriminatory ID from the protected region of the data storage medium mounted in the external memory slot. When the discriminatory ID matches the solid-state ID set for the electronic data usage device or in the case of a general use ID, the electronic data usage device is able to read electronic data. After reading the electronic data, the electronic data usage device writes the solid-state ID into the protected region of the data storage medium. Because the solid-state ID of the electronic data usage device that first performed the reading has been written into the data storage medium, the data in the data storage medium can no longer be read by another electronic data usage device.

The lower-order program of the conventional microcontroller 100 shown in FIG. 2A often has a compatible constitution in order to perform a predetermined same operation (e.g., function program) under a different main program. Hence, if the command code system of a CPU of another microcontroller (notshown) is the same as the microcontroller 100 (the varieties of microcontroller CPUs are limited and therefore the probability is high) and the lower-order program of the microcontroller 100 is copied illegally from the ROM 2 and used as a lower-order program of that another microcontroller, then that another microcontroller operates without any problems. The development of a lower-order program of a large-scale function program or the like in particular requires large development periods and costs so that the damage when fraudulent usage occurs is enormous.

Although the processor of Japanese Patent Application Kokai No. H11-345117 prevents the illegal use of programs, this processor cannot be a realistic means of solving the problems because enormous costs are incurred in the development of the processor itself and because there is a possibility that hardware and software resources and so forth that have been developed for existing CPUs cannot be used for the processor.

The illegal use prevention technologies disclosed in Japanese Patent Application Kokai No. 2001-209584 and Japanese Patent Application Kokai No. 2003-150457 are targeted toward personal computers that have external storage media premised on the inputting and outputting of software. Hence, the application to a control microcontroller is difficult.

### SUMMARY OF THE INVENTION

One object of the present invention is to provide a microcontroller capable of preventing the illegal use of a program by means of a simple constitution.

Another object of the present invention is to provide an authentication method for the microcontroller that can prevent the illegal use of a program.

Still another object of the present invention is to provide an authentication program for the microcontroller that can prevent the illegal use of a program.

According to one aspect of the present invention, there is provided an improved authentication method for a microcontroller. The microcontroller has a memory in which a program is stored and a processor that performs computation and/or control in accordance with the program stored in the memory. The authentication method includes the step of providing an authentication code generation unit that is accessed by the processor and generates authentication code. The authentication method also includes the step of reading the authentication code from the authentication code generation unit by means of the program, and the step of determining whether the authentication code thus read is normal.

According to another aspect of the present invention, there is provided a microcontroller that includes a memory in which a program is stored, and a processor that performs computation and/or control in accordance with the program stored in the memory. The microcontroller also includes an authentication code generation unit that holds data written by the processor as the authentication code and issues the authentication code in response to a read request from the processor.

Because the present invention has the authentication code generation unit for generating the authentication code upon the read request from the processor, it can be judged whether a combination of hardware and software in question is appropriate by checking the authentication code thus read. As a result, the illegal use of a program can be prevented by means of a simple constitution.

These and other objects, aspects and advantages of the present invention will become clearer upon reading the following description of the preferred embodiments and appended claims in conjunction with the attached drawings. It should be noted that the drawings are purely for explanation purposes and do not limit the scope of the present invention.

### BRIEF DESCRIPTION OF THE DRAWINGS

FIG. 1A shows a structure of a microcontroller according to a first embodiment of the present invention;

FIG. 1B is a software flowchart used by the microcontroller shown in FIG. 1A;

FIG. 2A shows a structure of a conventional microcontroller;

FIG. 2B is a software flowchart used by the microcontroller shown in FIG. 2A;

FIG. 3A illustrates a structure of a microcontroller according to a second embodiment of the present invention;

FIG. 3B is a software flowchart used by the microcontroller shown in FIG. 3A;

FIG. 4A illustrates a block diagram of a modified authentication code register which can be used for the microcontroller of FIG. 3A;

FIG. 4B illustrates a block diagram of another authentication code register which can also be used for the microcontroller of FIG. 3A;

FIG. 5A illustrates a first modification to the setting section shown in FIG. 4A or FIG. 4B;

FIG. 5B illustrates a second modification to the setting section shown in FIG. 4A or FIG. 4B; and

FIG. 5C illustrates a third modification to the setting section shown in FIG. 4A or FIG. 4B.

### DETAILED DESCRIPTION OF THE INVENTION

Now, embodiments of the present invention will be described with reference to the drawings.

### FIRST EMBODIMENTS

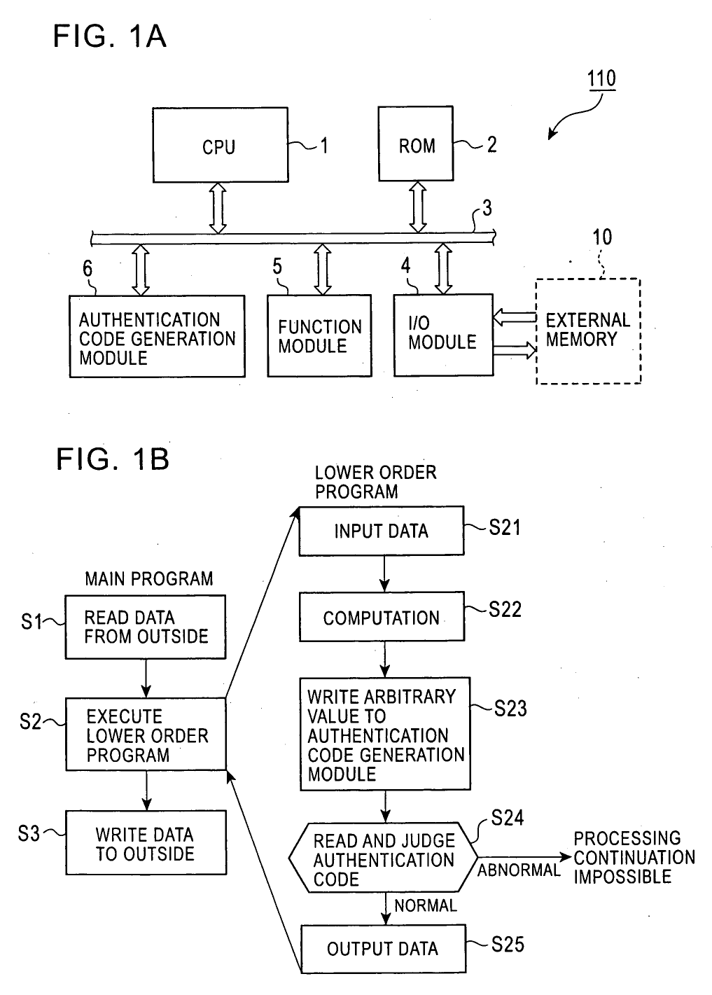

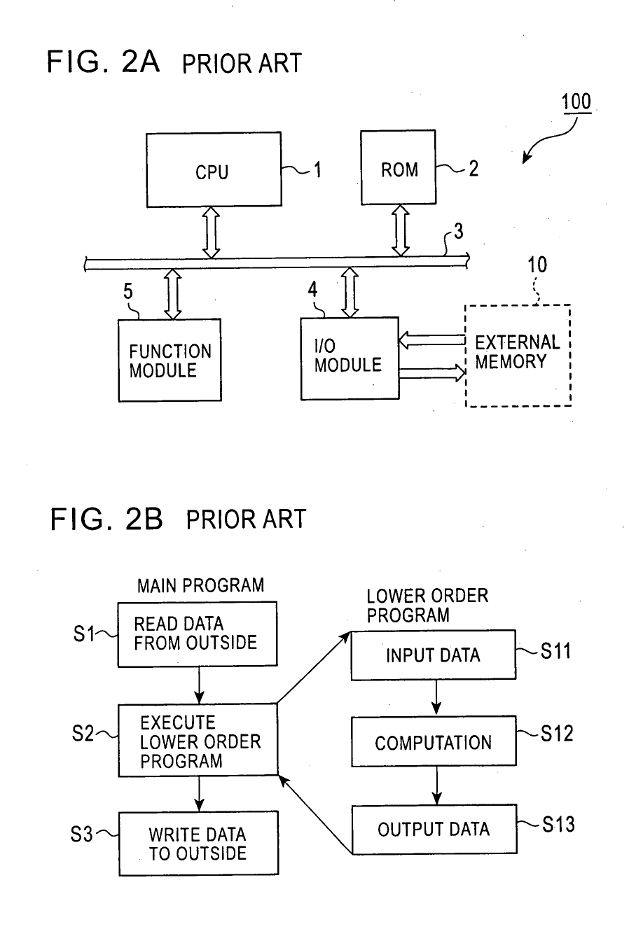

Referring to FIGS. 1A and 1B, a microcontroller 110 according to the first embodiment of the present invention will be described. FIG. 1A shows a hardware structure of the microcontroller 110, and FIG. 1B shows a software flowchart. In FIGS. 1A, 1B, 2A and 2B, same or similar numerals and symbols are assigned to same or similar to elements.

As shown in FIG. 1A, the microcontroller 110 has a CPU 1 that performs processing and control in accordance with a program. The microcontroller 110 also has a ROM 2 on which the program is stored. The CPU 1 and ROM 2 are connected to each other via a bus 3. An I/O module 4 sends and receives data to and from an external memory 10 or the like. The input/output module 4, an authentication code generation module 6, and another functional module 5 are also connected to the bus 3.

The authentication code generation module 6 has a register that enables reading and writing via the bus 2 from the CPU 1. That is, the authentication code generation module 6 holds a certain value written from the CPU 1 and supplies the value as “true authentication code” when there is a read request from the CPU 1. Preferably, the authentication code generation module 6 is installed on a high-speed bus in order to reduce the time taken to access the authentication code generation module 6. A user of the microcontroller 110 can enter an arbitrary value as the true authentication code.

The operation of the microcontroller 110 will be described next. It should be assumed that the true authentication code is already stored in the module 6.

As shown in FIG. 1B, the software that controls the operation of the microcontroller 110 includes a main program that controls the overall processing in accordance with the functions of the microcontroller 110 and a plurality of lower-order programs such as a function program that is activated by the main program to perform a particular process. It should be noted that for the sake of simplicity FIG. 1B shows only one of the lower-order programs.

In step S1 of the main program, the CPU 1 reads data from the external memory 10 via the I/O module 4. The lower-order program is then activated in step S2 and the data are handed over to the lower-order program from the main program.

As a result, the operation of the lower-order program is started. In step S21, the handover of the data (input data) to the lower-order program is performed, and in step S22 computation in accordance with the input data is executed. When the computation of step S22 is complete, a certain value (“entered authentication code”) is written into the authentication code generation module 6 in step S23. Thereafter, the true authentication code that has been written to the authentication code generation module 6 is read in step S24, and it is determined whether the true authentication code matches the value (i.e., the entered authentication code) written in step S23.

When it is determined in step S24 that the entered authentication code is correct, the processing moves to step S25 to generate the data (output data) of the computation result, and the processing moves to the main program. In step S3 of the main program, the CPU 1 receives the output data generated by the lower-order program and writes this output data into the external memory 10 via the output module 4.

If it is judged in step S24 that the entered authentication code is incorrect (abnormal), a continuation of the processing becomes impossible and the program runs out of control. It should be noted that other way of design is also acceptable when the entered authentication code is incorrect. For example, when it is judged in step S24 that the entered authentication code is incorrect, the execution of the program may be terminated or the processing may return to the main program without generating the output data in the lower-order program.

As described above, the microcontroller 110 of the first embodiment has the authentication code generation module 6 which holds any values written from the CPU 1 as authentication code and generates the authentication code upon a read request. The microcontroller 110 reads the authentication code from the authentication code generation module 6 while the lower-order program is being executed, in order to see the matching between the true authentication code and the entered authentication code (steps S23 and S24). The steps S23 and S24 are contained in the lower-order program stored in the ROM 2. Entry of the true authentication code is also carried out in the lower-order program.

If the software is illegally extracted from the ROM 2 and another microcontroller that does not possess the authentication code generation module 6 (e.g., the microcontroller 100 shown in FIG. 2A) is operated with that illegally extracted software, the authentication code entry in step S23 cannot be carried out because there is no authentication module 6. Also, the comparison between the entered authentication code and the true authentication code in step S24 cannot be carried out because there is no authentication module 6. There is no way to read the true authentication code even if someone wants to perform the authentication code matching. Hence, the program ends abnormally and the intended processing can no longer be performed. Therefore, illegal use of the program can be prevented by means of a simple constitution.

### SECOND EMBODIMENT

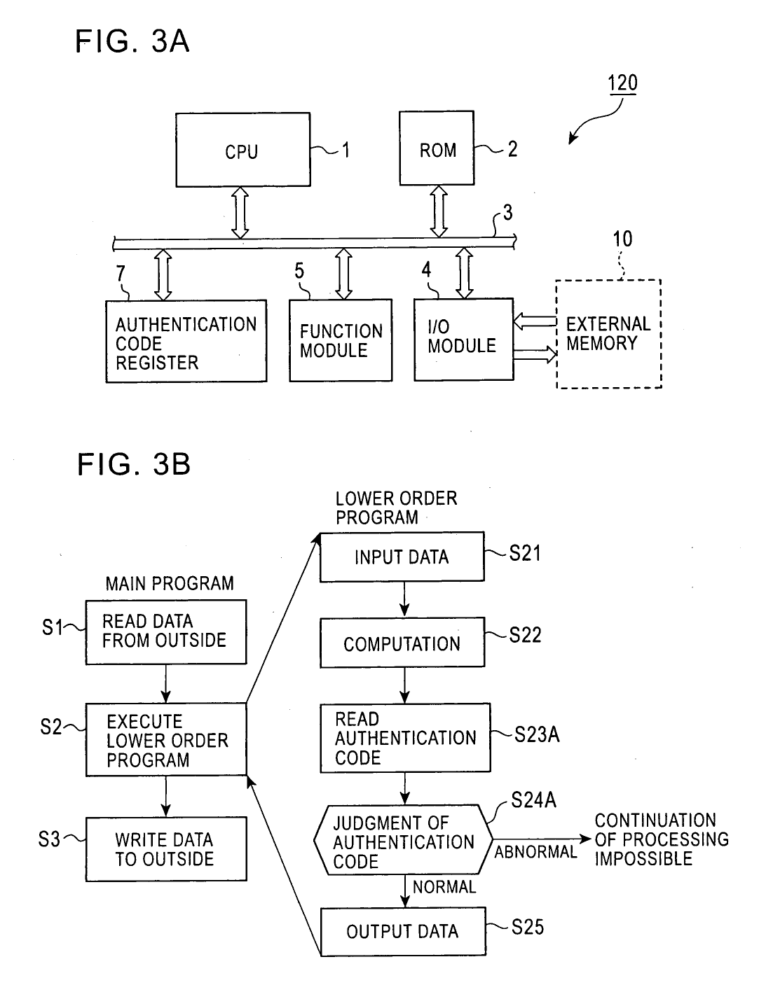

FIGS. 3A and 3B show the microcontroller 120 according to the second embodiment of the present invention. FIG. 3A is a hardware constitutional view and FIG. 3B is a software operation flowchart. In FIGS. 1A, 1B, 3A and 3B, same or similar reference symbols and numerals are assigned to same or similar elements and processing.

The microcontroller 120 of the second embodiment has an authentication code register 7 instead of the authentication code generation module 6 of the microcontroller 110 shown in FIG. 1A. Also, the lower-order program of the second embodiment has steps S23A and S24A with slightly different processing content from that of steps S23 and S24 (FIG. 1B) in the lower-order program of the first embodiment.

The authentication code register 7 is a ROM in which a predetermined value is pre-stored as authentication code. The CPU 1 can read the authentication code from the ROM via the bus 3.

The authentication code is also included in the lower-order program beforehand.

Step S23A reads the authentication code from the authentication code register 7, and step S24A determines whether or not the authentication code read in step S23A coincides with the authentication code included in the lower-order program. The remaining steps in FIG. 3B are the same as the first embodiment (FIG. 1B).

The operation of the microcontroller 120 is the same as the operation of the microcontroller 110 shown in FIG. 1A except for a fact that writing of the authentication code by means of the lower-code program is not performed and a fact that the authentication judgment is performed by reading the authentication code from the authentication code register 7.

As described above, the microcontroller 120 of the second embodiment has the authentication code register 7 in which the predetermined authentication code is written. The lower-order program of the second embodiment reads the authentication code from the code register 7 to perform the authentication process (steps S23A and S24A). The lower-order program is stored in the ROM 2.

As a result, when the software is illegally extracted from the ROM 2 and another microcontroller (e.g., the microcontroller shown in FIG. 2A) that does not have the authentication code register 7 is operated with that illegally extracted software, it is judged to be abnormal in the judgment processing of step S24A because the authentication code is not read in step S23A. Hence, the program ends abnormally and the intended processing can no longer be executed. Therefore, the second embodiment has the same advantage as the first embodiment.

In the first embodiment, an authentication code is written as a true authentication code, and it is read to confirm whether an entered authentication code matches the read (true) authentication code. Thus, if the microcontroller 100 of FIG. 2A has a readable/writable register, and the software is illegally copied and used for the microcontroller 100 of FIG. 2A, then there is a possibility that the authentication code is written in the read/writable register in the microcontroller 100 of FIG. 2A and will be used as the true authentication code. In this instance, the lower-order program operates normally with the illegally copied software. In the second embodiment, however, because the authentication code is only allowed to read, a user of the microcontroller 100 of FIG. 2A cannot write its own authentication code in register as a true authentication code. Under such circumstances, a value read from the register of the microcontroller 100 of FIG. 2A hardly matches the true authentication code. Further, if the true authentication code is divided and stored in a plurality of consecutive addresses or registers, the probability of the authentication code matching becomes even smaller.

### THIRD EMBODIMENT

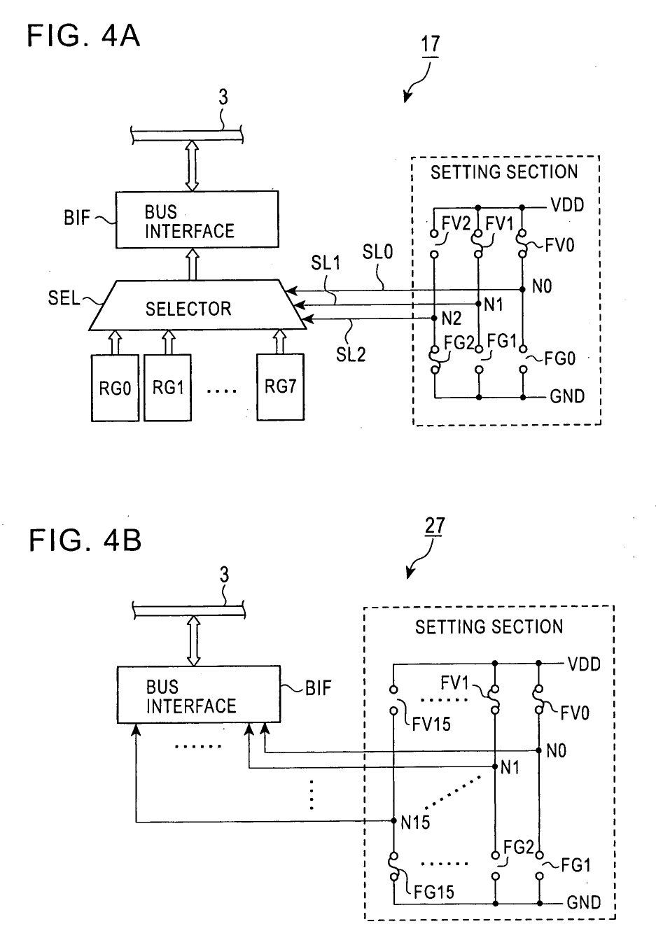

FIG. 4A and FIG. 4B show two authentication code registers 17 and 27 according to the third embodiment of the present invention. One of these authentication code registers 17 and 27 is provided instead of the authentication code register 7 in FIG. 3A.

The authentication code register 17 of FIG. 4A includes a plurality of registers RG0 to RG7. Each register RG0 to RG7 is a ROM or the like for storing a unique value as its own authentication code. The authentication code register 17 also includes a selector that selects one of the registers RG0 to RG7 in accordance with the select signals SL0 to SL2. This authentication code register 17 also includes a bus interface BIF that sends the value of the register selected by the selector to the bus 3 in accordance with the read request from the CPU 1, and a setting section that generates the select signals SL0 to SL2.

The setting signal has nodes N0, N1 and N2 that issue the select signals SL0, SL1 and SL2, respectively. The nodes NO to N2 are connected to a supply potential VDD by the fuses FV0 to FV2, respectively, and the nodes N0 to N2 are connected to a ground potential GND by the fuses FGO to FG2, respectively. One fuse in each pair of fuses (FV0, FG0), (FV1, FG1), (FV2, FG2) in the setting section is broken by a laser beam or the like at the manufacturing stage, so that the select signals SL0 to SL2 of level “H” (high) or level “L” (low) are sent to the nodes N0 to N2, respectively. Thus, the authentication codes can be changed based on which fuses are disconnected and which selection signal is given.

The authentication code register 27 in FIG. 4B includes a setting section having nodes N0 to N15 that generate 16-bit authentication code, for example, and a bus interface BIF that sends the authentication code supplied from the nodes N0 to N15 to the bus 3 in accordance with a read request from the CPU 1. The constitution of the setting section is the same as the setting section in FIG. 4A.

The authentication code registers 17 and 27 of FIGS. 4A and 4B are able to set different authentication codes by changing the set values of the setting section. Therefore, when another hardware that has an authentication code register as does the already purchased hardware is newly purchased and the newly purchased hardware is operated by means of the lower-order program illegally extracted from the previously purchased hardware, the new hardware cannot operate normally because there is no match with the authentication code set in the lower-order program. That is, the authentication code can be changed for each customer by manufacturing a different interior which is decided by a fact that which fuses are disconnected. Therefore, even when the same hardware is purchased, the usage of an illegally obtained program by a customer who has not purchased the program can be prevented. However, the manufacturer must prepare the corresponding lower-order program for each authentication code set for the hardware.

Modifications

The present invention is not limited to the above described embodiments and a variety of modifications and changes can be made to the embodiments within the scope of the present invention. For example, the following modifications and changes are possible.

(1) The lower-order programs of FIGS. 1B and 3B perform an authentication code judgment after performing computation but may perform the authentication code judgment before computation.

(2) In FIGS. 1B and 3B, a program is divided into a main program and a lower-order program, and the authentication code judgment is performed by the lower-order program. However, the authentication code judgment may be performed by the main program. There is no need to divide the program into a main program and a lower-order program in the present invention.

(3) The number of bits of authentication code is arbitrary.

(4) The authentication code generation module 6 accepts an arbitrary value as authentication code and uses that value as it is, but the module 6 may generate authentication code by performing a predetermined computation for the entered arbitrary value.

(5) The setting section in each of FIGS. 4A and 4B decides the select signal and authentication code by the breaking of fuses but may decide the select signal and authentication code by means of a mask pattern.

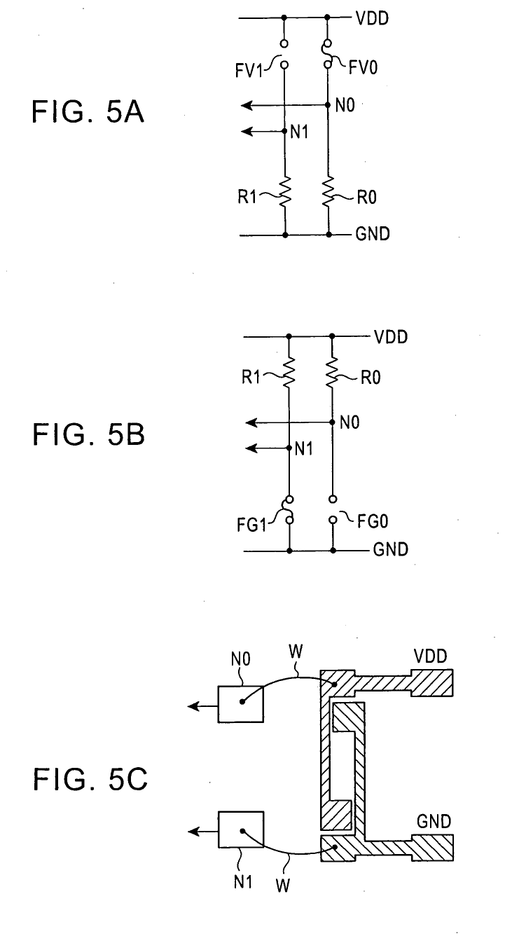

(6) The constitution of the setting section is not limited to the constitution illustrated in FIG. 4A and FIG. 4B. FIGS. 5A to 5C illustrate three modifications to the setting section shown in FIG. 4A or FIG. 4B. These modifications will be described below.

In the setting section shown in FIG. 5A, the nodes N0 and N1 are connected to the supply potential VDD by means of the fuses FVO and FV1, respectively, and the nodes N0 and N1 are connected to the ground potential GND by means of the high resistances R0 and R1, respectively. This setting section pulls down the nodes to “L” which is the ground potential level by breaking the fuses.

In the setting section shown in FIG. 5B, the nodes N0 and N1 are connected to the supply potential VDD by means of the high resistances R0 and R1, and the nodes N0 and N1 are connected to the ground potential GND by means of the fuses FV0 and FV1. This setting section pulls up the nodes to “H” which is the supply potential level by breaking the fuses.

The setting section of FIG. 5C has bonding pads provided on the nodes N0 and N1, and the nodes N0 and N1 are connected to the supply potential VDD and ground potential GND of the lead frame of the package by means of bonding wires W. Because the setting section of FIG. 5C does not use fuses, an arbitrary value can be established for the authentication code by means of a general wire bonding device without the need for a special device such as a laser trimming device.

This application is based on Japanese Patent Application No. 2006-10641 filed on Jan. 19, 2006, and the entire disclosure thereof is incorporated herein by reference.

What is claimed is:

1. An authentication method for a microcontroller that includes a memory in which a program is stored and a processor that performs computation and/or control in accordance with the program stored in the memory, the authentication method comprising:
providing an authentication code generation unit that is accessed by the processor to generate an authentication code;
reading the authentication code from the authentication code generation unit under the control of the program; and
determining whether the authentication code thus read is normal.

2. The authentication method for a microcontroller according to claim 1, wherein the authentication code generation unit holds data written by the processor as the authentication code and generates the authentication code in response to a read request from the processor.

3. The authentication method for a microcontroller according to claim 1, wherein the authentication code generation unit holds a predetermined authentication code and generates the authentication code in response to a read request from the processor.

4. A microcontroller comprising:
a memory in which a program is stored;
a processor that performs computation and/or control in accordance with the program stored in the memory; and
an authentication code generation unit for holding data written by the processor as an authentication code and generating the authentication code in response to a read request from the processor.

5. A microcontroller comprising:
a memory in which a program is stored;
a processor that performs computation and/or control in accordance with the program stored in the memory; and
an authentication code generation unit for generating a predetermined authentication code in response to a read request from the processor.

6. The microcontroller according to claim 5, wherein the authentication code generation unit includes:
a plurality of registers, each of the plurality of registers holding a predetermined authentication code;
a selection signal generator for generating a select signal;
a selector that selects one of the plurality of registers on the basis of the select signal and takes the authentication code from the selected register as a selected authentication code; and
a bus interface that generates the selected authentication code in response to a request from the processor.

7. The microcontroller according to claim 5, wherein the authentication code generation unit includes:
a setting section that fixedly sets a multi-bit signal by means of a mask pattern, fuse break, or wire wiring; and
a bus interface that generates, as the authentication code, the multi-bit signal that is set by the setting section in response to a request from the processor.

8. An authentication program for a microcontroller that includes a memory in which a program is stored, a processor that performs computation and/or control in accordance with the program stored in the memory, and an authentication code generation unit that is accessed by the processor to generate an authentication code, the authentication program comprising:
reading the authentication code from the authentication code generation unit; and
determining whether the authentication code thus read is normal.

9. An authentication program for a microcontroller that includes a memory in which a program is stored, a processor that performs computation and/or control in accordance with the program stored in the memory, and an authentication code generation unit for holding data written by the processor as an authentication code and generating the authentication code in response to a read request from the processor, the authentication program comprising:
writing arbitrary data to the authentication code generation unit;
reading the authentication code from the authentication code generation unit;
continuing processing when the authentication code matches the written arbitrary data; and
stopping the processing when the authentication code does not match the written arbitrary data.

10. The authentication method for a microcontroller according to claim 3, wherein the authentication code generation unit includes a read-only memory to hold the predetermined authentication code.

11. The microcontroller according to claim 6, wherein each said register includes a read-only memory to hold the predetermined authentication code.
